(19) United States
(12) Patent Application Publication
(10) Pub. No.: US 2014/0197359 A1
(43) Pub. Date: Jul. 17, 2014

(54) OXYGEN-SCAVENGING COMPOSITION, SULFIDE GROUP-CONTAINING POLYESTER, AND OXYGEN-SCAVENGING PACKAGING ARTICLE

(71) Applicant: FAR EASTERN NEW CENTURY CORPORATION, Taipei City (TW)

(72) Inventors: Fa-Chen Chi, Taipei City (TW); Yi-Hsuan Tang, Taipei City (TW); Yu-Shiang Peng, Taipei City (TW); Wen-Teng Chang, Taipei City (TW)

(73) Assignee: FAR EASTERN NEW CENTURY CORPORATION, Taipei City (TW)

(21) Appl. No.: 14/152,940

(22) Filed: Jan. 10, 2014

(30) Foreign Application Priority Data
Jan. 15, 2013 (TW) 102101478

(51) Int. Cl. B65D 81/26; C08G 63/688

(52) U.S. Cl. CPC B65D 81/266; C08G 63/6886
USPC 252/188.2; 528/294

(57) ABSTRACT

An oxygen-scavenging composition includes a sulfide group-containing polyester and a catalyst. The sulfide group-containing polyester is obtained by subjecting a reaction composition to esterification and condensation reactions. The reaction composition includes an aromatic diacid component and a diol component including aliphatic diol and a diol compound represented by the following formula (I):

HO—(X¹—O)ₙ—X³—S—X⁴—(O—X²)ₘ—OH (I)

wherein X¹ and X² independently represent a C₁-C₆ alkylene group, X³ and X⁴ represent a C₆-C₁₀ arylene group, and m and n represent an integer ranging from 1 to 5. The catalyst is for inducing reaction between the sulfide group-containing polyester and oxygen.

### CROSS-REFERENCE TO RELATED APPLICATION

This application claims priority of Taiwanese Application No. 102101478, filed on Jan. 15, 2013.

### BACKGROUND OF THE INVENTION

1. Field of the Invention

The invention relates to an oxygen-scavenging composition, more particularly to an oxygen-scavenging composition comprising a sulfide group-containing polyester and a catalyst.

2. Description of the Related Art

Polyester is a conventional polymeric material usually used in manufacturing packaging articles. Among various types of polyester, polyethylene terephthalate (PET) is widely adopted due to its advantages, such as high transparency, high chemical stability, non-toxicity, odorlessness, low cost, high manufacturing yield, easy recycling, and so forth. However, when a PET packaging article is used for packaging oxygen-sensitive food or beverages, such as juice, beer, milk, etc., a trace amount of oxygen will still permeate through the packaging article and cause the oxygen-sensitive food or beverages to deteriorate.

Conventionally, packaging articles for preventing the oxygen-sensitive food or beverages from oxidation may include: (1) a passive oxygen barrier design by virtue of intrinsic oxygen barrier property; or (2) an active oxygen-scavenging design by virtue of oxidative chemical structure thereof to react with and thus deplete oxygen.

U.S. Pat. No. 6,074,758 discloses a conventional thermoplastic polymeric composition that is adapted for blocking oxygen passively and that is obtained by subjecting a reaction composition, which includes a diacid, and a diglycidyl ether, to polymeric reaction. The diacid is represented by the following formula (a):

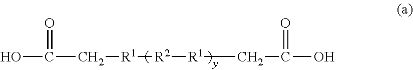

wherein R¹ represents —O—, —S—, or

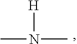

y represents 0 or 1, and R² represents an aromatic group or a C₆-C₃₀ heterocyclic group. The diglycidyl ether is represented by the following formula (b):

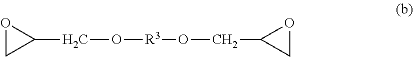

wherein R³ represents an aromatic group or a C₂-C₂₀ aliphatic group. However, this conventional thermoplastic polymeric composition can only provide a passive oxygen barrier property for packaging articles.

U.S. Pat. No. 6,083,585 discloses a conventional oxygen-scavenging composition comprising a copolymer and an oxidation catalyst. The copolymer includes polyester segments that are obtained by reacting an aromatic diacid component with a diol component, and polyolefin oligomer segments that are selected from the group consisting of polypropylene, poly(4-methyl)1-pentene, unhydrogenated polybutadiene, and mixtures thereof. The oxidation catalyst is cobalt octoate. By utilizing the polyolefin oligomer segments that are capable of reacting with oxygen, the active oxygen-scavenging effect is achieved. However, while preparing the oxygen-scavenging composition, the polyolefin oligomers have relatively low chemical compatibility with the aromatic diacid component, resulting in inconvenience during the manufacturing process. Therefore, there is a need in the art to provide an alternative active oxygen-scavenging composition, as well as to improve the oxygen-scavenging effect thereof.

### SUMMARY OF THE INVENTION

Therefore, the object of the present invention is to provide an oxygen-scavenging composition that may alleviate the aforementioned drawbacks of the prior art.

According to one aspect of the present invention, an oxygen-scavenging composition comprises a sulfide group-containing polyester and a catalyst. The sulfide group-containing polyester is obtained by subjecting a reaction composition to esterification and condensation reactions. The reaction composition includes an aromatic diacid component and a diol component that includes aliphatic diol and a diol compound. The diol compound is represented by the following formula (I):

HO—(X¹—O)ₙ—X³—S—X⁴—(O—X²)ₘ—OH (I)

wherein X¹ and X² independently represent a C₁-C₆ alkylene group, X³ and X⁴ independently represent a C₆-C₁₀ arylene group, and m and n independently represent an integer ranging from 1 to 5.

The catalyst is for inducing reaction between the sulfide group-containing polyester and oxygen.

According to another aspect of the present invention, a sulfide group-containing polyester is obtained by subjecting a reaction composition to esterification and condensation reactions. The reaction composition includes an aromatic diacid component and a diol component that includes aliphatic diol and a diol compound. The diol compound is represented by the following formula (I):

HO—(X¹—O)ₙ—X³—S—X⁴—(O—X²)ₘ—OH (I)

wherein X¹ and X² independently represent a C₁-C₆ alkylene group, X³ and X⁴ independently represent a C₆-C₁₀ arylene group, and m and n independently represent an integer ranging from 1 to 5.

According to yet another aspect of the present invention, an oxygen-scavenging packaging article comprises the abovementioned oxygen-scavenging composition.

### DETAILED DESCRIPTION OF THE PREFERRED EMBODIMENTS

### Sulfide Group-Containing Polyester

According to the present invention, a sulfide group-containing polyester is obtained by subjecting a reaction composition to esterification and condensation reactions. The reaction composition includes an aromatic diacid component and a diol component that includes aliphatic diol and a diol compound.

Preferably, the aromatic diacid component includes C₈-C₁₄ aromatic dicarboxylic acid. Examples of C₈-C₁₄ aromatic dicarboxylic acid may include, but are not limited to, terephthalic acid (TPA), isophthalic acid (IPA), phthalic acid, 2,6-naphthalenedicarboxylic acid, and 4,4′-Biphenyldicarboxylic acid. The aforesaid examples of C₈-C₁₄ aromatic dicarboxylic acid can be used alone or in admixture of two or more.

Preferably, the aliphatic diol of the diol component of the reaction composition includes C₂-C₁₂ aliphatic diol. Examples of the C₂-C₁₂ aliphatic diol may be, but are not limited to, ethylene glycol (EG), 1,3-propylene glycol, 1,2-propylene glycol, 1,2-cyclohexanedimethanol, 1,3-cyclohexanedimethanol, 1,4-cyclohexanedimethanol, 1,3-butylene glycol, 1,4-butylene glycol, 2,3-butylene glycol, 1,5-pentanediol, and 1,6-hexanediol. The aforesaid examples of the C₂-C₁₂ aliphatic diol may be used alone or in admixture of two or more.

Preferably, the diol compound of the diol component is represented by the following formula (I):

HO—(X¹—O)ₙ—X³—S—X⁴—(O—X²)ₘ—OH (I)

wherein X¹ and X² independently represent a C₁-C₆ alkylene group, X³ and X⁴ independently represent a C₆-C₁₀ arylene group, and m and n independently represent an integer ranging from 1 to 5. More preferably, X¹ and X² independently represent an ethylene group, X³ and X⁴ independently represent a phenylene group, and m and n independently represent 1. The aforesaid examples of the diol compound may be used alone or in admixture of two or more. In this embodiment, the diol compound is bis[4-(2-hydroxyethoxy)phenyl]sulfide (abbreviated as HEDS hereinafter).

Preferably, the diol compound is used in an amount ranging from 1 mol % to 70 mol % based on the total moles of the diol component of the reaction composition. More preferably, the diol compound is used in an amount ranging from 5 mol % to 50 mol %, most preferably from 5 mol % to 10 mol %, based on the total moles of the diol component of the reaction composition.

The reaction composition may further include a reaction catalyst for catalyzing the esterification reaction and/or the condensation reaction. Examples of the reaction catalyst may include, but are not limited to, antimony-containing compound (such as antimony (III) oxide, Sb₂O₃), germanium-containing compound, tin-containing compound, titanium-containing compound, gallium-containing compound, and aluminum-containing compound. The aforesaid examples of the reaction catalyst may be used alone or in admixture of two or more. There is no specific limitation on the amount of the catalyst used in the condensation reaction and/or the esterification reaction. Preferably, the operating temperature of the esterification reaction ranges from 220° C. to 260° C. Preferably, the operating temperature of the condensation reaction ranges from 260° C. to 280° C.

The sulfide group-containing polyester has an intrinsic viscosity greater than 0.5 dL/g.

### [Oxygen-Scavenging Composition]

The oxygen-scavenging composition according to the present invention comprises the aforementioned sulfide group-containing polyester and an oxidation catalyst. The term “oxygen-scavenging” refers to the ability of reacting with oxygen (oxidation), so as to reduce the amount of oxygen in the surrounding environment. According to the present invention, the sulfide groups contained in the sulfide group-containing polyester are capable of reacting with oxygen and being oxidized into sulfone groups or sulfoxide groups, so as to reduce the amount of oxygen in the surrounding environment. As for packaging articles, oxygen in the surrounding environment refers to oxygen in contact with the packaging articles.

The oxidation catalyst is capable of inducing a sulfide group in the sulfide group-containing polyester to react with oxygen. Preferably, the oxidation catalyst includes a transition metal-containing catalyst. The transition metal contained in the transition metal-containing catalyst may be, but is not limited to, ferrite, cobalt, nickel, ruthenium, rhodium, palladium, osmium, iridium, molybdenum, manganese, and platinum. More preferably, the transition metal-containing catalyst is selected from the group consisting of cobalt neodecanoate, cobalt acetate, ferric chloride, cobalt chloride, nickel sulfate, cobalt sulfate, manganese sulfate, molybdenyl acetylacetonate, molybdenum carbide, hexacarbonyl molybdenum, molybdenum trioxide, and combinations thereof.

Preferably, the oxidation catalyst is used in an amount ranging from 0.01 to 0.15 part by weight, more preferably, from 0.017 to 0.122 parts by weight, based on 100 parts by weight of the sulfide group-containing polyester.

There is no specific limitation for preparing the oxygen-scavenging composition. A conventional method for preparing the oxygen-scavenging composition may be implemented by utilizing an extruder, such as a twin-screw extruder or the like, to mix the oxidation catalyst thoroughly with the sulfide group-containing polyester.

### [Oxygen-Scavenging Packaging Article]

The oxygen-scavenging packaging article of the present invention comprises the aforementioned oxygen-scavenging composition.

There is no specific limitation on the production of the oxygen-scavenging packaging article. A conventional method for producing the oxygen-scavenging packaging article may be implemented by providing the oxygen-scavenging composition to an injection-molding machine to perform injection molding. The shape of the oxygen-scavenging packaging article of the present invention is not limited to bottles, cans, or bags. The oxygen-scavenging packaging article provides good transparency and has resistance against yellowing, and has a haze value ranging from 2% to 5.5%. An oxygen uptake ratio of the oxygen-scavenging packaging article ranges from 33% to 52%.

### EXAMPLES

### Synthesis Example 1

218 grams of 4-4′-thiodiphenol, 185 grams of ethylene carbonate (EC) and 3.06 grams of triphenylphosphine (TPP) were mixed together and were reacted at a temperature ranging from 160° C. to 180° C. for 8 hours to obtain a reaction product. The reaction product was washed with deionized water to remove residue of ethylene carbonate and was dried to obtain HEDS. The chemical structure of HEDS is shown as follows:

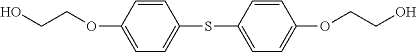 [SMILES: OCCOc1ccc(Sc2ccc(OCCO)cc2)cc1]

### Example (EX) 1

460.26 grams of TPA, 193.39 grams of EG, and 106.05 grams of HEDS were mixed together to form a mixture, followed by heating at a temperature ranging from 220° C. to 260° C. under nitrogen atmosphere (pressure ranged from 2 kg/cm² to 3 kg/cm²) for 6 hours to perform esterification reaction. Then, the reacted mixture was added with 0.18 gram of antimony (III) oxide as a catalyst and was heated at a temperature ranging from 260° C. to 280° C. in a vacuum condition (<5 torr) for 4 hours to perform condensation reaction, so as to obtain the sulfide group-containing polyester of EX 1 according to the present invention. The sulfide group-containing polyester of EX 1 has an intrinsic viscosity of 0.66.

### Example 2

505.89 grams of TPA, 231.46 grams of EG, and 23.31 grams of HEDS were mixed together to form a mixture and heated at a temperature ranging from 220° C. to 260° C. under nitrogen atmosphere (pressure ranged from 2 kg/cm² to 3 kg/cm²) for 6 hours to perform esterification reaction. Then, the reacted mixture was added with 0.18 gram of antimony (III) oxide as a catalyst and was heated up to a temperature ranging from 260° C. to 280° C. for 4 hours in a vacuum condition (<5 torr) to perform condensation reaction, so as to obtain the sulfide group-containing polyester of EX 2, which has an intrinsic viscosity of 0.63. Later, after feeding 600 grams of the sulfide group-containing polyester of EX 2 and 0.732 gram of cobalt neodecanoate into a twin-screw extruder followed by cutting, pellets of the oxygen-scavenging composition of EX 2 were obtained.

### Examples 3 to 8 and Comparative Example (CE) 1

The method for preparing the oxygen-scavenging composition of each of EXs 3 to 8 and CE 1 is similar to that of EX 2. The only difference resides in various type or amount of reactants used in the reaction composition, which are listed in Table 1.

### Comparative Example 2

CE 2 is a commercial PET product (Model: CB608, available from Far Eastern New Century Corporation).

### <Measurements>

### [Intrinsic Viscosity Measurement]

Each of the sulfide group-containing polyester of EX 1 and the oxygen-scavenging composition of EXs 2 to 8 and CE 1 was respectively added into a solvent containing phenol and tetrachloroethane (weight ratio of phenol to tetrachloroethane was 3/2), so as to form a sample solution with concentration of 0.4% wt/vol. The sample solution was then subjected to intrinsic viscosity measurement by using an Ubbelohde viscometer at a temperature of 30±0.02° C. The result of each of EXs 1 to EX 8 and CE 1 is listed in Table 1.

TABLE 1

| | | Aromatic diacid | | | | | | | |
|---|---|---|---|---|---|---|---|---|---|
| | | component | | | Diol component | | | Catalyst | Total weight of sulfide |
| | | (100 mol %) | | | (100 mol %) | | Intrinsic | (parts by | Group-containing |
| | | TPA | IPA | TDPA | EG | HEDS | Viscosity | weight)* | Polyester |
| EX 1 | gram | 460.26 | — | — | 193.39 | 106.05 | 0.66 | — | 600 |
| | mol % | 100 | — | — | 90 | 10 | | | |
| EX 2 | gram | 505.89 | — | — | 231.46 | 23.31 | 0.63 | C-1 (0.732 g) | 600 |
| | mol % | 100 | — | — | 98 | 2 | | 0.122 | |
| EX 3 | gram | 463.37 | 24.39 | — | 216.33 | 56.19 | 0.67 | C-1 (0.732 g) | 600 |
| | mol % | 95 | 5 | — | 95 | 5 | | 0.122 | |
| EX 4 | gram | 460.26 | — | — | 193.39 | 106.05 | 0.65 | C-1 (0.732 g) | 600 |
| | mol % | 100 | — | — | 90 | 10 | | 0.122 | |
| EX 5 | gram | 317.20 | — | — | 74.04 | 365.45 | 0.67 | C-1 (0.732 g) | 600 |
| | mol % | 100 | — | — | 50 | 50 | | 0.122 | |
| EX 6 | gram | 274.53 | — | — | 38.45 | 442.81 | 0.56 | C-1 (0.732 g) | 600 |
| | mol % | 100 | — | — | 30 | 70 | | 0.122 | |
| EX 7 | gram | 460.26 | — | — | 193.39 | 106.05 | 0.73 | C-2 (0.315 g) | 600 |
| | mol % | 100 | — | — | 90 | 10 | | 0.0525 | |
| EX 8 | gram | 460.26 | — | — | 193.39 | 106.05 | 0.63 | C-3 (0.102 g) | 600 |
| | mol % | 100 | — | — | 90 | 10 | | 0.017 | |
| CE 1 | gram | 463.93 | — | 55.34 | 240.66 | — | 0.39 | C-1 (0.732 g) | 600 |
| | mol % | 90 | — | 10 | 100 | — | | 0.122 | |

*Based on 100 parts by weight of the sulfide group-containing polyester.
C-1 cobalt neodecanoate
C-2 cobalt acetate
C-3 molybdenyl acetylacetonate

As shown in Table 1, each of EXs 1 to 8 has relatively high intrinsic viscosity in comparison to CE 1, thereby resulting in better adaptability associated with manufacturing processes of the packaging article. As for CE 1, aliphatic sulfide bonding of TDPA pyrolyzes easily at high temperature, thereby having poor intrinsic viscosity property.

### [Oxygen Uptake Ratio Determination]

10 grams of each of the oxygen-scavenging composition of EXs 2 to 8 and CE 2 were respectively placed in a sealed sampling vessel of a trace oxygen monitoring system (model No. MC-8G, purchased from Iijima Electronics Co., Japan). The sampling vessel was filled with oxygen having an initial oxygen concentration of 20.9%, the temperature of the sampling vessel was 26° C., and the relative humidity of the sampling vessel was 60% RH. The oxygen concentration in the sampling vessel was measured once every 3 days for a 20-day period, and the oxygen uptake ratio of each of EXs 2 to 8 and CE 2 is determined by the following formula:

O₂ Uptake Ratio=(20.9%−X%)/20.9%

wherein X % represents oxygen concentration in the sampling vessel measured in the last day of the 20-Day period. The results are listed in Table 2.

TABLE 2

| | | Oxygen Concentration (%) | | | | | | | |
|---|---|---|---|---|---|---|---|---|---|
| | | EX | | | | | | | CE |
| | | 2 | 3 | 4 | 5 | 6 | 7 | 8 | 2 |
| Testing | 0 | 20.9 | 20.9 | 20.9 | 20.9 | 20.9 | 20.9 | 20.9 | 20.9 |
| Period | 3 | — | 19.1 | 19.0 | 19.0 | 18.9 | 20.0 | 19.3 | 20.9 |
| (days) | 6 | 18.8 | 17.7 | 17.8 | 17.6 | 17.0 | 19.5 | 16.7 | — |
| | 9 | 17.6 | 16.5 | 16.7 | 16.8 | 15.7 | 19.0 | 15.6 | 20.5 |
| | 12 | — | 15.5 | — | — | — | — | 14.8 | — |
| | 15 | 16.0 | 14.7 | 13.2 | 12.9 | 13.2 | 17.3 | — | — |
| | 18 | 15.2 | 14.0 | 13.1 | 11.5 | — | — | — | — |
| | 20 | 14.0 | 13.8 | 12.8 | 10.5 | 10.1 | 10.3 | 13.4 | 20.3 |

| | | | | | | | | |
|---|---|---|---|---|---|---|---|---|
| Oxygen uptake | 33.01 | 33.97 | 38.75 | 49.76 | 51.67 | 50.72 | 35.89 | 2.87 |
| ratio (%) | | | | | | | | |

As shown in Table 2, CE 2 has poor oxygen uptake ratio since the commercial PET product thereof does not contain the sulfide group-containing polyester and the catalyst according to the present invention. As for EXs 2 to 8 of the present invention, the oxygen-scavenging compositions thereof have relatively high oxygen uptake ratios due to presence of the sulfide group-containing polyester and the catalyst, thereby allowing the packaging articles made therefrom to prolong safe storage period of oxygen-sensitive products.

### [X-Ray Photoelectron Spectroscopy Analysis]

The sulfide group-containing polyester of EX 1 and the oxygen-scavenging composition of EX 4 were placed under oxygen atmosphere at 26° C. for 20 days to perform oxidative reaction, and were subjected to X-ray photoelectron spectroscopy (XPS, Model: K-alpha, from Thermo Fisher Scientific) for analyzing peak values and intensity (peak area) ratio of sulfide group (—S—), sulfoxide group (—SO—), and sulfone group (—SO₂—) in the Sulfur 2 p range (160 eV to 175 eV). The results are listed in Table 3.

TABLE 3

| | Peak value (eV) & | | |
|---|---|---|---|
| | Peak Area ratio (%) in XPS | | |
| | Spectrum | | |
| | —S— | —SO— | —SO₂— |
| EX 1 | 163.0 eV | 165.8 eV | 168.0 eV |
| | 68.7% | 28.2% | 3.0% |
| EX 4 | 162.6 eV | 165.9 eV | 168.1 eV |
| | 7.2% | 56.9% | 35.9% |

As shown in Table 3, 92.8% of the sulfide groups in the sulfide group-containing polyester of EX 4 were oxidized into the sulfone groups and the sulfoxide groups. In contrast, only 31.3% of the sulfide groups in the sulfide group-containing polyester of EX 1 were oxidized into the sulfone groups and the sulfoxide groups, proving that the sulfide group-containing polyester of the present invention needs the catalyst to improve the oxygen-scavenging effect.

### [Colorimetric and Haze Measurements]

The oxygen-scavenging composition of each of EXs 2 to 8 was processed through injection molding to obtain the oxygen-scavenging packaging article, respectively. The oxygen-scavenging packaging article was then cut into a test sample provided with a length of 30 mm, a width of 30 mm, and a thickness of 0.3 mm. The test sample was subjected to colorimetric measurement using a colorimeter (Model: Color Meter NE4000, manufactured using Nippon Denshoku Company) and to haze measurement by a hazemeter (Model: Haze Meter NDH2000, manufactured by Nippon Denshoku Company). The results are listed in Table 4.

TABLE 4

| | Lab color | | | |
|---|---|---|---|---|
| | coordinates | | | Haze value |
| | L | a | b | (%) |
| EX 2 | 16.9 | −0.4 | 0.3 | 2.8 |
| EX 3 | 16.1 | −0.38 | 0.32 | 3.2 |
| EX 4 | 15.13 | −0.42 | 0.34 | 3.52 |
| EX 5 | 13 | −0.44 | 0.58 | 4.8 |
| EX 6 | 11 | −0.41 | 0.67 | 5.27 |
| EX 7 | 15.20 | −0.3 | 0.59 | 4.91 |
| EX 8 | 15.09 | −0.21 | 0.7 | 5.1 |

As shown in Table 4, the packaging articles of EXs 2 to 8 have relatively low haze values (2.8% to 5.27%), resulting in high transparency. Moreover, from the Lab color coordinates, the packaging articles of EXs 2 to 8 do not exhibit yellowing phenomenon.

To sum up, by incorporating the sulfide group-containing polyester with the catalyst in the oxygen-scavenging composition of the present invention, the sulfide groups are capable of reacting with oxygen and converting into the sulfone groups and suloxide groups, so that the oxygen-scavenging packaging article made therefrom can prevent oxygen permeation, and prolong the safe storage period of the oxygen-sensitive products contained therein.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An oxygen-scavenging composition comprising:
a sulfide group-containing polyester obtained by subjecting a reaction composition to esterification and condensation reactions, said reaction composition including an aromatic diacid component and a diol component that includes aliphatic diol and a diol compound; and
a catalyst for inducing reaction between said sulfide group-containing polyester and oxygen;
wherein said diol compound is represented by the following formula (I):
HO—(X¹—O)ₙ—X³—S—X⁴—(O—X²)ₘ—OH (I)
wherein X¹ and X² independently represent a C₁-C₆ alkylene group, X³ and X⁴ independently represent a C₆-C₁₀ arylene group, and m and n independently represent an integer ranging from 1 to 5.

2. The oxygen-scavenging composition as claimed in claim 1, wherein X¹ and X² independently represent an ethylene group, X³ and X⁴ independently represent a phenylene group, and m and n independently represent 1.

3. The oxygen-scavenging composition as claimed in claim 1, wherein said diol compound is in an amount ranging from 1 mol % to 70 mol % based on the total moles of said diol component.

4. The oxygen-scavenging composition as claimed in claim 3, wherein said diol compound is in an amount ranging from 5 to 50 mol %.

5. The oxygen-scavenging composition as claimed in claim 1, wherein said aromatic diacid component of said reaction composition includes C₈-C₁₄ aromatic dicarboxylic acid.

6. The oxygen-scavenging composition as claimed in claim 1, wherein said aliphatic diol of said diol component of said reaction composition includes C₂-C₁₂ aliphatic diol.

7. The oxygen-scavenging composition as claimed in claim 1, wherein said catalyst includes a transition metal-containing catalyst.

8. The oxygen-scavenging composition as claimed in claim 7, wherein said transition metal-containing catalyst is selected from the group consisting of cobalt neodecanoate, cobalt acetate, ferric chloride, cobalt chloride, nickel sulfate, cobalt sulfate, manganese sulfate, molybdenyl acetylacetonate, molybdenum carbide, hexacarbonyl molybdenum, molybdenum trioxide, and combinations thereof.

9. The oxygen-scavenging composition as claimed in claim 1, wherein said catalyst is in an amount ranging from 0.01 to 0.15 part by weight based on 100 parts by weight of the oxygen-scavenging composition.

10. A sulfide group-containing polyester, obtained by subjecting a reaction composition to condensation and esterification reactions, said reaction composition including an aromatic diacid component and a diol component that includes aliphatic diol and a diol compound, said diol compound being represented by the following formula (I):
HO—(X¹—O)ₙ—X³—S—X⁴—(O—X²)ₘ—OH (I)
wherein X¹ and X² independently represent a C₁-C₆ alkylene group, X³ and X⁴ independently represent a C₆-C₁₀ arylene group, and m and n independently represent an integer ranging from 1 to 5.

11. The sulfide group-containing polyester as claimed in claim 10, wherein X¹ and X² independently represent an ethylene group, X³ and X⁴ independently represent a phenylene group, and m and n independently represent 1.

12. The sulfide group-containing polyester as claimed in claim 10, wherein said diol compound is in an amount ranging from 1 mol % to 70 mol % based on the total moles of said reaction composition.

13. The sulfide group-containing polyester as claimed in claim 12, wherein said diol compound is in an amount ranging from 5 to 50 mol %.

14. The sulfide group-containing polyester as claimed in claim 10, wherein said aromatic diacid component of said reaction composition includes a C₈-C₁₄ aromatic dicarboxylic acid.

15. The sulfide group-containing polyester as claimed in claim 10, wherein said aliphatic diol of said diol component of said reaction composition includes a C₂-C₁₂ aliphatic diol.

16. An oxygen-scavenging packaging article, comprising the oxygen-scavenging composition as claimed in claim 1.
